(19) United States
(12) Patent Application Publication
(10) Pub. No.: US 2007/0169427 A1
(43) Pub. Date: Jul. 26, 2007

(54) Decorative grid system and method

(76) Inventors: David Eugene Lee III, Avondale Estates, GA (US); Matthew David Kennedy, Woodstock, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/338,357

(22) Filed: Jan. 24, 2006

(51) Int. Cl. E06B 3/964

(52) U.S. Cl. 52/204.61

(57) ABSTRACT

A window muntin apparatus and system, and methods for forming the same. The muntins are formed from a substrate of a lignocellulosic material that has been applied with a desired muntin shape and machined by a computerized numerically controlled (CNC) machine. In general, the substrate of a lignocellulosic material is typically formed by impregnating a substrate of a lignocellulosic-material with an isocyanate-resin material, removing excess isocyanate-resin material from the impregnated substrate by impinging air at a high flow rate upon the impregnated substrate, polymerizing the resin by applying water to the impregnated substrate, the water being at a temperature sufficient for polymerization and removing the water from the polymerized resin-impregnated surface.

### BACKGROUND

I. Field of the Invention The present invention relates generally to the field windows and more particularly to a decorative grid and muntin system and method.

II. Description of the Related Art.

Muntins are typically used in many types of windows in order to provide decoration for both insulated glass also known as glass between glass (GBG) and simulated divided light (SDL) windows. IG windows are known to be multiple panes of glass, typically two panes, being spaced thereby creating an air space between the panes. The panes are sealed thereby becoming what is considered a single pane of glass having an insulating air space. GBG windows are advantageous because the insulating barrier between the panes results in energy conservation. Prior to sealing the two panes together, muntins are often placed between the panes to provide decoration. Typical muntins are metal, plastic or wood. Regardless of the type of material, muntins present several problems in the GBG windows. For example, excessive heating and exposure to sunlight cause the muntins to warp and discolor causing a permanent unaesthetic appearance of the GBG window. Furthermore, the heat and light causes outgassing in the muntins in which is the release of moisture and liquid from the material. The outgassing causes the moisture to be retained between the panes resulting in permanent clouding on the panes of glass that cannot be removed. For several of the materials used in present muntins, expensive and prolonged treatment, such as painting and heat curing, is required before placement of the muntins between the panes of glass. Muntins can also be used on SDL glass to give the appearance of true divided light (TDL) windows, which are typically more difficult and time consuming to manufacture. The use of muntins for SDL windows can also cause similar problems associated with GBG window muntins, such as warping and discoloring, often cause by heat, sunlight and local offgassing.

### SUMMARY

In general, the invention features a decorative grid (muntin) system and method. The muntins are formed from a substrate of a lignocellulosic-material that has been applied with a desired muntin shape and machined by a computerized numerically controlled (CNC) machine. In general, the substrate of a lignocellulosic-material is typically formed by impregnating a substrate of a lignocellulosic-material with an isocyanate resin material, removing excess isocyanate resin material from the impregnated substrate by impinging air at a high flow rate upon the impregnated substrate, polymerizing the resin by applying water to the impregnated substrate, the water being at a temperature sufficient for polymerization and removing the water from the polymerized resin-impregnated surface.

In general, in one aspect, the invention features a window system, including a pane of glass and a window muntin located adjacent the pane of glass, wherein the window muntin is formed from a substrate of a lignocellulosic-material.

In one implementation, the substrate of the lignocellulosic-material is water-resistive.

In another implementation, the lignocellulosic-material substrate is formed by impregnating a substrate of a lignocellulosic-material with an isocyanate resin material removing excess isocyanate resin material from the impregnated substrate by impinging air at a high flow rate upon the impregnated substrate, polymerizing the resin by applying water to the impregnated substrate, the water being at a temperature sufficient for polymerization and removing the water from the polymerized resin-impregnated surface.

In another implementation, the polyisocyanate-impregnated substrate contains 0.5-20% polyisocyanate by weight.

In another implementation, the polyisocyanate-impregnated substrate has a moisture content of less than 10%.

In another implementation, the pane of glass and the muntin are adhered together as an SDL configuration

In another implementation, the system further includes a second pane of glass generally parallel to the pane of glass, the muntin being located therebetween.

In another implementation, the system further includes a spacer connected along outer edges of the panes of glass and the muntin.

In another implementation, the panes of glass and the muntin are connected together in a GBG configuration.

In another aspect, the invention features a method of manufacturing a window muntin, including creating a design of the window muntin, forming a substrate of a lignocellulosic material, forming the design of the window muntin on the substrate of the lignocellulosic material and cutting the design of the window muntin from the substrate of the lignocellulosic material.

In one implementation, the substrate of lignocellulosic material is formed by impregnating a substrate of a lignocellulosic material with an isocyanate resin material, removing excess isocyanate resin material from the impregnated substrate by impinging air at a high flow rate upon the impregnated substrate, polymerizing the resin by applying water to the impregnated substrate, the water being at a temperature sufficient for polymerization; and removing the water from the polymerized resin-impregnated surface.

In another aspect, the invention features a window muntin, including a substrate of a polyisocyanate-impregnated lignocellulosic material having 0.5-20% polyisocyanate by weight, the substrate being formed into a pre-selected shape.

In one implementation, the substrate contains 2.0-15% polyisocyanate by weight.

In another implementation, the substrate contains 5.0-10% polyisocyanate by weight.

In another implementation, the substrate contains 7.0-8.0% polyisocyanate by weight.

In another aspect, the invention features an improved window muntin being positioned between two panes of glass and sealed therebetween, wherein the improvement comprises means for reducing the moisture content of a lignocellulosic substrate of the muntin to less than 7% during formation of the muntin, thereby reducing the outgassing of the muntin.

In another implementation, the invention features an improved method of forming a window of the type having two panes of glass having a spaced defined therebetween, the space being sealed from external environmental conditions, the improvement comprising forming a muntin for placement within the airspace prior to sealing the airspace, the muntin being formed by a substrate of a lignocellulosic material impregnated with an isocyanate resin material that is polymerized by applying water to the impregnated substrate at a temperature sufficient for polymerization.

In another aspect, the invention features a window muntin made by the process, including forming a planar sheet form a substrate of a lignocellulosic material impregnated with an isocyanate resin material, forming a decorative grid design on the planar sheet and cutting out the decorative grid design with a computerized numerically controlled machine to form the muntin.

In one implementation, the process further includes optionally smoothing rough portions from the muntin and optionally finishing the muntin with at least one of paint and stain, and optionally air dried.

In another implementation, the process further includes placing the muntin in a glass between glass configuration.

In another implementation, the process further includes placing the muntin in a simulated divided light configuration.

In another implementation, the isocyanate resin comprises a preservative.

In another implementation, the preservative is chosen from the group consisting of: bactericides, fungicides and insecticides.

In another implementation, the preservative comprises from 0.25% to 10% of the isocyanate resin material by weight.

In another implementation, the isocyanate-resin material further comprises a flame retardant.

In another implementation, the flame retardant is chosen from the group consisting of: tris(1,3-dichloroisopropyl)phosphates and dimethyl methalphosphenate.

In another implementation, the flame retardant comprises from 0.25% to 5.00% by weight of the resin material.

In general, the substrates and boards used for the muntins can be formed by a variety of methods, including, but not limited to the following described methods.

In one implementation, the muntin substrates and boards can be formed by a method for increasing the strength and water resistance of a substrate of a lignocellulosic material, including impregnating a substrate of a lignocellulosic material with an isocyanate resin material, removing excess isocyanate resin material from the impregnated substrate by impinging air at a high flow rate upon the impregnated substrate, polymerizing the resin by applying water to the impregnated substrate, the water being at a temperature sufficient for polymerization, and removing the water from the polymerized resin-impregnated substrate.

The method can further include selecting an air knife system for providing the high flow rate of impinging air upon the impregnated substrate.

The method can further include selecting the substrate from lignocellulosic fibers and binder.

The method can further include selecting the binder from urea-formaldehyde resin or phenol-formaldehyde resin.

The method can further include maintaining the liquid at a temperature greater than or equal to about 180° F.

The method can further include maintaining the water at a temperature in the range of about 180° F. to about 212° F.

The method can further include maintaining the water at a temperature of about 180° F.

The method can further include dehydrating the substrate in an oven before impregnation until a moisture content of less than about 7% by weight is achieved.

The method can further include applying a plurality of streams of water to the substrate of a lignocellulosic material.

The method can further include maintaining the pressure of the isocyanate resin material impregnate at about 1 atmosphere.

The method can further include maintaining the isocyanate resin material at a temperature of about 150° F.

The method can further include selecting the isocyanate resin material from methylene diphenyl diisocyanate resin material.

The method can further include selecting the isocyanate resin material from methylene diphenyl diisocyanate resin material, said methylene diphenyl diisocyanate resin material having a content of about 33% to about 49% of 4, 4′-methylene diphenyl diisocyanate, less than about 70% of poly(methylene diphenyl diisocyanate), less than about 10% of mixed methylene diphenyl diisocyanate isomers, and less than about 8% of 2,4′-methylene diphenyl diisocyanate.

The method can further include selecting the isocyanate resin material from those having an —N═C═O content in a range of about 1% to about 33% by weight of the isocyanate resin material.

The method can further include selecting the isocyanate resin material from those having an —N═C═O content of about 10% to about 33% by weight of the isocyanate resin material.

The method can further include selecting the isocyanate resin material from those having an —N═C═O content of about 23% to about 32% by weight of the isocyanate resin material.

The method can further include selecting the isocyanate resin material from those having a —N═C═O functionality of about 2 to about 3.

The method can further include selecting the isocyanate resin from those having a viscosity at 25° C. of about 50 to about 300 Centipoise.

The method can further include selecting the lignocellulosic material from either high density fiberboard, medium density fiberboard, oriented strand board, particle board, hemp, sisal, cotton stalk, wheat, straw, bamboo, jute, salt water reeds, palm fronds, flax, groundnut shells, hard woods, or soft woods.

The method can further include selecting the lignocellulosic material from medium density fiberboard.

The substrates and boards used for the muntins can also be formed by a method for increasing the strength and water resistance of a substrate of a lignocellulosic material, including impregnating a substrate of a lignocellulosic material with an isocyanate resin material, polymerizing the resin by applying water to the impregnated substrate, the water being at a temperature sufficient for polymerization and removing the water from the polymerized resin-impregnated substrate.

One advantage of the invention is that it provides a muntin that does not degrade or warp.

Another advantage of the invention is that it provides a muntin that does not yellow, fade or otherwise discolor.

Another advantage of the invention is that it provides a muntin that does not require heat curing during production.

Another advantage of the invention is that it provides a muntin that does not offgas.

Another advantage of the invention is that it provides a muntin that does not contribute to moisture sealed between double pane windows.

Another advantage of the invention is that it provides a muntin that does not absorb moisture.

Another advantage of the invention is that it provides a muntin that can be painted or otherwise coated and air dried.

Another advantage of the invention is that it can easily be beveled, textured or otherwise shaped.

Another advantage of the invention is that a unitary one piece window muntin can be manufactured.

Another advantage of the invention is that the methods described herein can be used to form window muntins as well as muntins for doors and other windows.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1 illustrates an embodiment of a window muntin 100 formed of a polyisocyante-impregnated lignocellulosic material and shaped into a desired configuration;

FIG. 2 illustrates two embodiments of muntin retaining pins;

FIG. 3 illustrates an end view of an embodiment of the muntin as illustrated in FIG. 1 showing holes drilled into ends; and

FIG. 4 illustrates an embodiment of a GBG window system.

### DETAILED DESCRIPTION

The embodiments described herein can be used for a large variety of muntin types, including but not limited to GBG and SDL windows. Regardless of the type of window, the muntin is typically formed by creating a desired muntin pattern on a substrate or board of a lignocellulosic-material that has been impregnated with an isocyanate resin that is polymerized, to form a polyisocyante-impregnated lignocellulosic material. The desired pattern is then cut from the board, typically using a CNC overhead router previously drawn on a CAD program. In a typical embodiment, the board used to form the muntins from the computerized numerically controlled (CNC) overhead router is 4′×8′. In addition, the board can generally have a thickness of 0.238—1.27 cm, and having typical thicknesses of, including but not limited to 0.318, 0.635 and 0.953 cm.

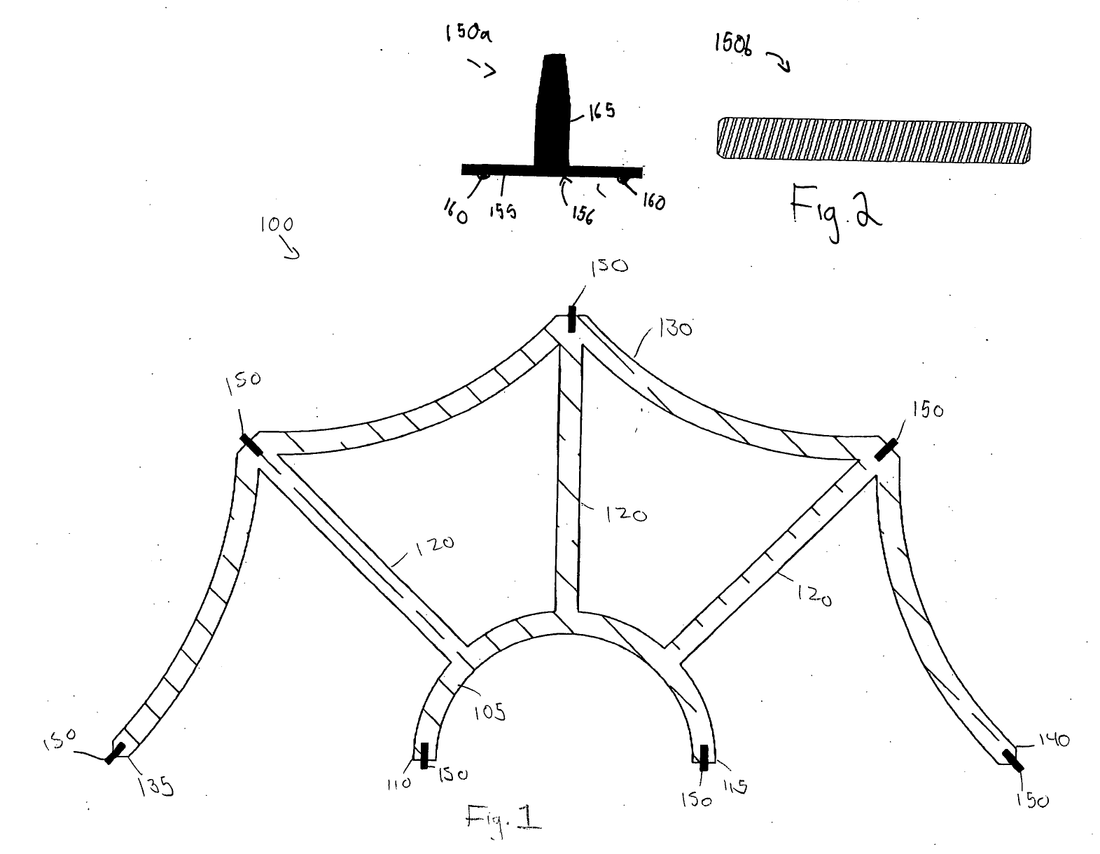

Typical muntins have a larger variety of shapes and sizes. FIG. 1 illustrates an embodiment of a window muntin 100 formed of apolyisocyante-impregnated lignocellulosic material and shaped into a desired configuration. In the embodiment, the muntin 100 has a semi-circular inner rim 105 having terminal ends 110, 115 and three protruding bars 120 connected generally along the circumference of the inner rim 105. A patterned outer rim 130 is connected to the ends of the bars 120, the outer rim 130 being generally concentric with the semi-circular inner rim 105. The outer rim 130 typically includes terminal ends 135, 140. It is appreciated that the rims 105, 130 and bars 120 are typically an integral piece formed and cut from the polyisocyante-impregnated lignocellulosic material, and share a common plane of orientation.

After the cutting machine has cut out the muntin 100, the muntin 100 is typically checked for smoothness. If desired, the muntin 100 can be sanded, typically with a fine grit sand paper and then cleaned. When a desired texture is achieved the muntin 100 is optionally painted or stained. When the paint has cured, the muntin 100 can further be processed, the processing depending on the muntin 100 types. For glass between glass (GBG) muntins, as shown with muntin 100 in FIG. 1, a0.159 cm ( 1/16 inch)-wide hole is typically drilled into the ends of the bars 120, and the terminal ends 110, 115 of the inner rim 105 and the terminal ends 135, 140 of the outer rim 130. The holes are drilled parallel to the plane of orientation, to a depth generally ranging from about 0.841 to 1.27 cm. It is under stood that a variety of depths are possible depending on the application. A retaining pin 150 is placed into each of the drilled holes. Typically the retaining pin 150 is used to connect the muntin 100 to its final position between panes of glass typically to a spacer as described further below, directly into a frame or into other orientations.

FIG. 2 illustrates two embodiments 150a, 150bof retaining pins 150 as just described. In one embodiment, the retaining pin 150a is a pin having a generally planar head 155, which can be square or rectangular, and a shaft 165 having a depth suitable to fit into holes drilled into the ends 110, 115, 135, 140 as described above. The shaft 165 can further be advantageously tapered at the end in order to provide ease of insertion into the holes and thicker toward the head 155 to provide a snug fit. The head 155 can further include one or more dimples 160 positioned along an upper surface 156 of the head 155, the dimples 160 generally providing a frictional fit when placed adjacent a spacer as described further below.

In another embodiment, the retaining pin 150b is an elongated cylindrical shaft having tapered ends for affixation into the holes of the ends 110, 115, 135, 140 as described above and for insertion into holes provided on window frames when fit directly into structures.

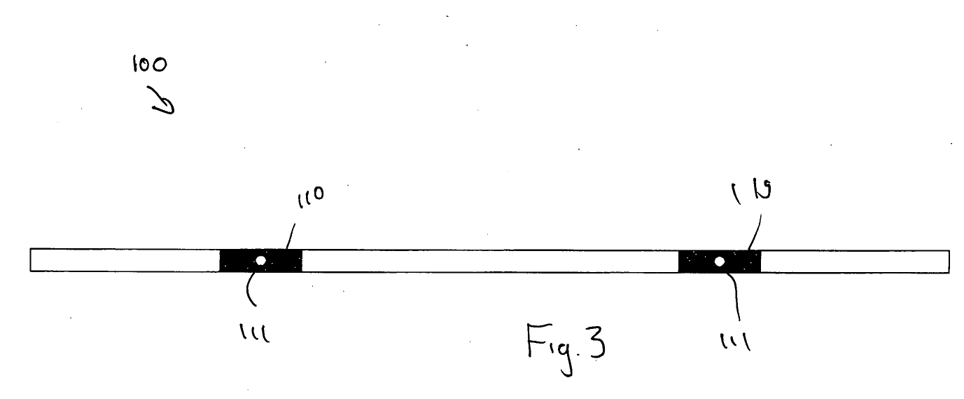

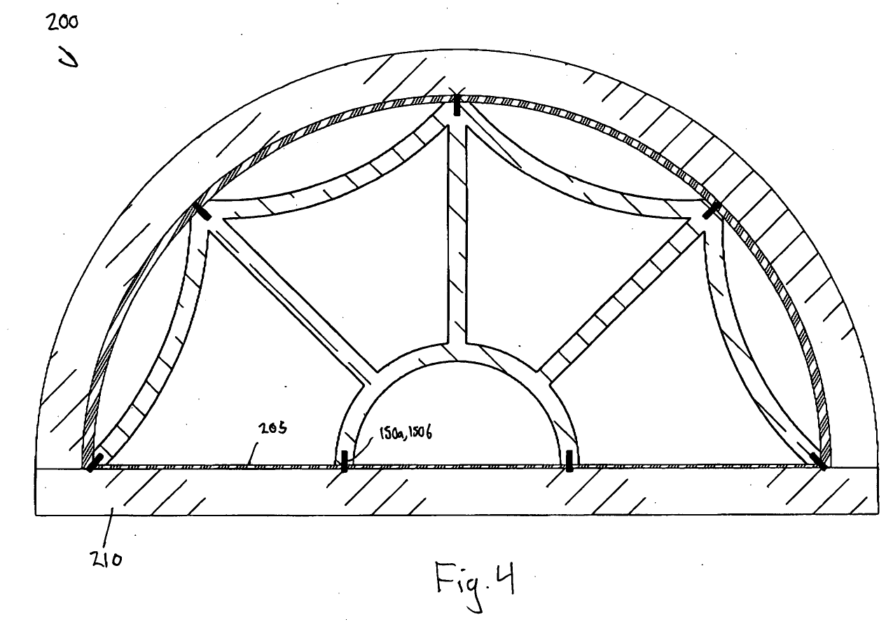

FIG. 3 illustrates an end view of an embodiment of the muntin 100 as illustrated in FIG. 1 showing holes 111 drilled into ends 110, 115.

FIG. 4 illustrates an embodiment of a GBG window system 200. The system 200 includes an embodiment of a muntin 100 as described above. The muntin 100 is connected to a spacer 205 that is connected to a window frame 210. As described above, either embodiment of the connector pins 150a, 150b can be used to connect the muntin 100 to the spacer 205.

In another implementation, the muntin 100 can be formed as described for GBG use, but be modified for SDL use. For SDL muntins, no holes are typically drilled into the ends 110, 115, 135, 140. Instead, one side of the SDL muntin is wiped clean providing a clean, smooth and dry surface onto which adhesive, such as two sided tape can be affixed for subsequent attachment to glass for an SDL window.

In general, by polymerizing an isocyanate resin-impregnated lignocellulosic substrate by applying a heated liquid to it, the substrate used for the muntin has increased strength, water resistance, rot resistance, and termite resistance and has a smooth, relatively non-glossy, satin-like finish, which is desirable for use for muntins either unfinished or finished with a stain or paint. In addition, by passing the isocyanate resin-impregnated lignocellulosic substrate through an air knife system, the resin can be impregnated more deeply and uniformly into the lignocellulosic substrate, while at the same time removing excess resin from the surface of the substrate. The lignocellulosic substrate used to produce the muntin is made of lignocellulosic material, typically a material containing both cellulose and lignin. Often, such lignocellulosic material is in a fibrous form. Suitable lignocellulosic materials include wood particles, wood fibers, straw, hemp, sisal, cotton stalk, wheat, bamboo, jute, salt water reeds, palm fronds, flax, groundnut shells, hard woods, or soft woods, as well as fiberboards such as high density fiberboard, medium density fiberboard (MDF), oriented strand board and particle board. Although wheat straw and other bodies of annual plants contain some lignin, they are sometimes not referred to as lignocellulosic materials. However, for purposes of the present invention these annual plants are included within the term “lignocellulosic material”. The lignocellulosic substrate is preferably medium density or high density fiberboard.

In general, the lignocellulosic substrate can be molded or non-molded, and may be in the form of a strip, panel, block, sheet, veneer or any suitable shape form or pattern for muntin production.

In a typical embodiment, the lignocellulosic substrate is dried at a dehydration station. Stock lignocellulosic substrates can typically have a moisture content of about 3-8% by weight. In general, even lower moisture content is important for achieving maximum strength and penetration by the isocyanate resin material. When methylene diphenyl diisocyanate (MDI) is used as the isocyanate resin material, water in the lignocellulosic material tends to react with the MDI to form a urea linkage. This urea linkage is weaker than that of the urethane linkage between the cellulose molecules and the polyisocyanate obtained after polymerizing the isocyanate resin material, thus it reduces the overall potential strength of the final product, as compared to a drier substrate treated as described above. For each gram of water removed from the lignocellulosic substrate, approximately one gram of isocyanate resin replaces it in the polyisocyanate-impregnated lignocellulosic substrate. The dehydration typically results in a lignocellulosic substrate with a moisture content of less than 7% by weight. It is typically desirable to have the moisture content at about 0.1-2.5% by weight for maximum efficiency as a muntin, thereby preventing outgassing after placement in the GBG or SDL windows.

The substrate is typically dried by heated air from a blower and heater system set between 200° F. and 300° F. The heated air exiting the dehydration station is diverted to another second blower for post-impregnation drying at station. It is understood that other blower and heater combinations can be used for drying, including, but not limited to a catalytic infra-red heater designed to achieve up to a 350° F. surface temperature on the lignocellulosic substrate. The substrate as formed does not outgas and thus does not require a coating to be applied thereto. After subsequent steps, a coating such as paint or stain can be optionally applied and air dried.

The dried lignocellulosic substrate is typically impregnated with an isocyanate resin material at an impregnation station. The isocyanate resin material is heated by a resin heater and transported by a pump from a reservoir to a series of applicator nozzles, where the resin material is applied to, and impregnated into, the dried substrate. Excess resin material is collected in the reservoir below the applicator nozzles and subsequently reused. The reservoir and pumping system allows isocyanate resin material to be continuously reapplied to the substrate, thus shortening the impregnation time and preventing waste of the isocyanate resin material. Isocyanate resin material is allowed to contact the surfaces of the substrate for about 4-10 minutes, but typically for 4 minutes.

The dried substrate can alternatively be impregnated by soaking it in a soaking tank filled with heated resin material. Typically, if soaking is chosen for performing the impregnation step, lignocellulosic substrates inside the soaking tank are preferably kept submerged for 4-10 minutes to insure full penetration of the isocyanate resin, but the actual soak time typically depends upon the thickness and density of the substrate. The tank is preferably maintained at atmospheric pressure, but a pressurized soak tank may be used in order to shorten the soak time for thicker or denser substrates. When the tank is not in use, a dry inert gas at atmospheric pressure and room temperature is applied to the headspace to extend the resin's pot life.

Whether application by a series of nozzles or by soaking is chosen, the degree of impregnation of the isocyanate resin material into the lignocellulosic substrate is generally governed by the viscosity and temperature of the isocyanate resin material, and the length of time and pressure at which the resin material is applied to the substrate. For example, an isocyanate resin material having a lower viscosity or one being maintained at a higher temperature is impregnated into the substrate more quickly than one having a higher viscosity or one being maintained at a lower temperature. Similarly, a higher pressure or longer application time results in greater impregnation than a lower pressure or shorter application time. If MDI is chosen for the isocyanate resin material, viscosities for MDI products (in Centipoise) at various temperatures may be found in the following table:

Viscosity (in Centipoise) of
various MDI products at different temperatures

| | 25° C. | 50° C. | 60° C. |
|---|---|---|---|
| MDI Product | (77° F.) | (122° F.) | (140° F.) |
| Lupranate M-20 S (BASF) | 200 | | 25 |
| Elastocast 7034 U (BASF) | 700 | 96 | 58 |
| WUC 3092 T (BASF) | 700 | 128 | |
| Desmodur VKS-18 (Bayer) | 150-250 | | |
| E-743 (Bayer) | 1700-3300 | | |
| X0672 (Bayer) | 300-800 | | |

During the impregnation step, the isocyanate resin material reacts with the wood cellulose. The isocyanate forms a chemical bond between the hydroxyl groups of the wood cellulose, thus forming a urethane linkage. This chemical bond contributes to the improved strength of the final product. The isocyanate resin molecules, whether bonded to cellulose molecules or not, do not polymerize to any significant extent during the impregnation step.

The isocyanate resin material is preferably an MDI material. The structure of MDI is depicted by formula, O═C═N—Ph—CH₂—Ph—N═C═O. More preferably, the isocyanate resin material contains 4,4′-methylene diphenyl diisocyanate, where Ph is a phenyl group.

Commercial preparations of the isocyanate resin material typically contain not only 4,4′-methylene diphenyl diisocyanate, but also poly(methylene diphenyl diisocyanate) otherwise known as polymeric MDI (or PMDI), mixed methylene diphenyl diisocyanate isomers, and 2,4′-methylene diphenyl diisocyanate. If methylene diphenyl diisocyanate resin material is chosen for the isocyanate resin material, it preferably has a content of about 33% to about 49% of 4,4′-methylene diphenyl diisocyanate, less than about 70% of poly(methylene diphenyl diisocyanate), less than about 10% of mixed methylene diphenyl diisocyanate isomers, and less than about 8% of 2,4′-methylene diphenyl diisocyanate. Most preferably, the MDI employed in the invention will have about 45% methylene diphenyl diisocyanate, with the balance being poly(methylene diphenyl diisocyanate).

The MDI material should have high —N═C═O content, preferably an —N═C═O content of greater than 33% (by wt.), more preferably 1-33% (by wt.), even more preferably 10-33% (by wt.), and most preferably 23-32% (by wt.). The MDI material will preferably have a high —N═C═O functionality, more preferably from 2 to 3, most preferably closer to 3 than 2. The MDI material preferably has a viscosity of 50-300 Centipoise (at 25° C. ), more preferably closer to 50 than 300. If desired, the MDI material may be used in combination with a non-polar solvent in a proportions of 10-100% (by wt.) of MDI and 0-90% (by wt.) of non-polar solvent.

The isocyanate resin material can also include a preservative, such as a bactericide, fungicide or insecticide or the like, preferably in an amount of from 0.25% to 10% by weight of the resin material. Examples of such biocides are complexes of boron, atrazines, thiazoles and carbamates. The isocyanate resin material can also include other additives such as fire or flame retardant chemicals, including but not limited to tris(1,3-dichloroisopropyl)phosphates, or dimethyl methalphosphenate. These fire or flame retardants can comprise from 0.25% to 5.00% by weight of the resin material.

Excess resin is removed from the surface of the impregnated substrate at a resin removal station, and the chemical reaction between the isocyanate and cellulose molecules is accelerated by an elevated temperature. In addition to resin removal at station, impregnated resin is also heated to the elevated temperature of 240-300° F. and forced toward the middle of the substrate. The chemical reaction between the isocyanate resin and the cellulose molecules begins at temperatures as low as 212° F. At the resin removal station, the impregnated substrate is passed by an air knife set. At the air knife set, heated air from a heater is directed onto surfaces of the substrate by a blower. The air knife set itself is a pair of long tubes each having a long slit for egress of heated air at an elevated pressure onto the surfaces of the impregnated substrate. While the air flow, velocity and temperature through the air knife set can be varied, the air flow, velocity and temperature are preferably maintained at about 800 ft³/min, about 15,000-35,000 ft/min, and about 240-300° F., respectively. As heated air impinges upon the surface of the impregnated substrate from the air knives, some of the excess resin not fully impregnated into the substrate is forced further into the substrate, while the remainder is blown off, thereby preventing a film or skin of resin material from forming on the substrate surface.

The impregnated isocyanate resin material is polymerized at apolymerization station by applying a liquid to the impregnated substrate at a temperature sufficient for polymerization of the isocyanate material. The liquid is contained in a second reservoir, where it is heated by a heater, pumped by a pump, and applied to the impregnated substrate by applicator nozzles. Surfaces of the impregnated substrate cure to a darker appearance if they are not covered with the heated liquid, so it is preferable to ensure full coverage of all the surfaces with the heated liquid. The flow of liquid through the nozzles is preferably maintained at about 5-10 gpm at a pressure of 5-6 psi. After flowing off the surfaces of the impregnated substrate, the heated liquid is collected in the second reservoir where it can be reused.

Suitable liquids include those materials that exist in a liquid form (under atmospheric pressure) at the polymerization temperature of the isocyanate resin material, and which also do not substantially inhibit the polymerization reaction. The liquid is preferably reactive toward the isocyanate resin material, thus forming reaction products at the surface of the substrate. The liquid is selected so that the reaction products between it and the resin can be more easily removed from the surface of the substrate, than compared to polymerized isocyanate resin at the surface of the substrate. For example, if water and MDI are selected as the liquid and isocyanate resin, they react to form water soluble materials containing urea linkages. Because the reaction products formed at the surface of the substrate are soluble in the liquid, the resultant appearance of the treated surface of the substrate is that of a smooth, satin-like and relatively non-glossy board. A preferred liquid is water. The liquid may be maintained at a temperature of equal to or greater than 180° F., preferably at between 180° F. and 212° F., and most preferably at about 180° F. The liquid may be applied to the impregnated substrate for a period of 8-10 minutes, but shorter or longer times may be selected depending upon the thickness of the lignocellulosic substrate.

Reaction products can result from a reaction between the heated liquid and the isocyanate resin material, and gradually build up in the second reservoir along with fibers from the lignocellulosic substrate. As the reaction product builds up, it can be removed by filtering liquid in second reservoir. A hot liquid make-up source supplies fresh liquid to second reservoir to replace liquid diminished through evaporation and filtration.

Alternatively, the resin in the impregnated substrate can be polymerized by soaking the impregnated substrate in heated liquid inside a soaking tank equipped with a circulation pump and a heater.

Excess liquid is removed from the polyisocyanate-impregnated substrate at a liquid removal station. This removal is accomplished by the use of a second air knife set (also including a heater and blower) maintained at the same air flow and temperature as the first set of air knives. As heated air impinges upon the surface of the substrate from the air knife, excess liquid and any resin-liquid reaction product formed at the surface of the substrate are blown off the substrate.

Alternatively, the liquid removal step may be performed by merely removing the polyisocyanate-impregnated substrate from the liquid and allowing the liquid to drain.

Alternatively, the polyisocyanate-impregnated substrate may be dried for about 10 minutes in an oven set at 200° F.-300° F.

In any case, a moisture content of less than 10% is preferred.

In general, the increased strength of the muntin material can be contributed to urethane linkages between —OH groups on the cellulose molecules of the lignocellulose fibers and —N═C═O groups on the isocyanate resin, urea linkages formed by the reaction of water bound in the lignocellulose fibers and —N═C═O groups of the excess isocyanate resin, a polyurethane chain formed by polymerization of the isocyanate resin, a polyurea chain formed by polymerization of the reaction product of bound water and excess isocyanate resin, encapsulation of the lignocellulose fibers by the polyurea chains as described in above, encapsulation of the lignocellulose fibers by the polyurethane chain formed by polymerization of the isocyanate resin, cross-linking of the polyisocyanate chains.

The polyisocyanate-impregnated substrate for the formation of the muntin contains 0.5-20%, preferably 2.0-15%, more preferably 5.0-10%, and most preferably 7.0-8.0% polyisocyanate by weight.

The material for use as substrate for the embodiments of the muntins described herein can advantageously be formed into board sizes suitable for use with the computerized numerically controlled machines so that suitable muntins of varying designs can be formed.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A window system, comprising:
a pane of glass; and
a window muntin located proximate the pane of glass, wherein the window muntin is formed from a substrate of a lignocellulosic-material.

2. The system as claimed in claim 1, wherein the substrate of the lignocellulosic-material is water-resistive.

3. The system as claimed in claim 2, wherein the lignocellulosic-material substrate is formed by:
impregnating a substrate of a lignocellulosic material with an isocyanate resin material;
removing excess isocyanate resin material from the impregnated substrate by impinging air at a high flow rate upon the impregnated substrate;
polymerizing the resin by applying water to the impregnated substrate, the water being at a temperature sufficient for polymerization; and
removing the water from the polymerized resin-impregnated surface.

4. The system as claimed in claim 3, wherein the polyisocyanate-impregnated substrate comprises 0.5-20% polyisocyanate by weight.

5. The system as claimed in claim 3, wherein the polyisocyanate-impregnated substrate has a moisture content of less than 10%.

6. The system as claimed in claim 1, wherein the pane of glass and the muntin are adhered together as an SDL configuration.

7. The system as claimed in claim 1 further comprising a second pane of glass generally parallel to the pane of glass, the muntin being located therebetween.

8. The system as claimed in claim 7 further comprising a spacer disposed along outer edges of the panes of glass and the muntin.

9. The system as claimed in claim 7 wherein the panes of glass and the muntin are connected together in a GBG configuration.

10. A method of manufacturing a window muntin, the method comprising:
creating a design of the window muntin;
forming a substrate of a lignocellulosic material;
forming the design of the window muntin on the substrate of the lignocellulosic material; and
cutting the design of the window muntin from the substrate of the lignocellulosic material.

11. The method as claimed in claim 10 wherein the substrate of lignocellulosic material is formed by:
impregnating a substrate of a lignocellulosic material with an isocyanate resin material;
removing excess isocyanate resin material from the impregnated substrate by impinging air at a high flow rate upon the impregnated substrate;
polymerizing the resin by applying water to the impregnated substrate, the water being at a temperature sufficient for polymerization; and
removing the water from the polymerized resin-impregnated surface.

12. A window muntin, comprising:
a substrate of a polyisocyanate-impregnated lignocellulosic-material having 0.5-20% polyisocyanate by weight, the substrate comprising a pre-selected shape.

13. The muntin as claimed in claim 12 wherein the substrate comprises 2.0-15% polyisocyanate by weight.

14. The muntin as claimed in claim 12 wherein the substrate comprises 5.0-10% polyisocyanate by weight.

15. The muntin as claimed in claim 12 wherein the substrate comprises 7.0-8.0% polyisocyanate by weight.

16. An improved window muntin disposed between two panes of glass and sealed therebetween, wherein the improvement comprises means for reducing the moisture content of a lignocellulosic substrate of the muntin to less than 7% during formation of the muntin, wherein outgassing of the muntin is reduced.

17. An improved method of forming a window having two panes of glass having a spaced defined therebetween, the space being sealed from external environmental conditions, the improvement comprising forming a muntin for placement within the airspace prior to sealing the airspace, the muntin being formed from a substrate of a lignocellulosic-material impregnated with an isocyanate resin material that is polymerized by applying water to the impregnated substrate at a temperature sufficient for polymerization.

18. A window muntin made by the process, comprising:
forming a planar sheet from a substrate of a lignocellulosic-material impregnated with an isocyanate resin material;
programming a CNC machine to form a decorative grid design on the planar sheet; and
cutting out the decorative grid design with a CNC machine to form the muntin.

19. The process as claimed in claim 18, further comprising:
optionally smoothing rough portions from the muntin; and
optionally finishing the muntin with a coating chosen from the group consisting of paint and stain.

20. The process as claimed in claim 19 further comprising placing the muntin in a GBG configuration.

21. The process as claimed in claim 19 further comprising placing the muntin in a SDL configuration.

22. The process as claimed in claim 18, wherein the isocyanate resin comprises a preservative.

23. The process as claimed in claim 22, wherein the preservative is chosen from the group consisting of: bactericides, fungicides and insecticides.

24. The process as claimed in claim 22, wherein the preservative comprises from 0.25% to 10% of the isocyanate resin material by weight.

25. The process as claimed in claim 18, wherein the isocyanate-resin material further comprises a flame retardant.

26. The process as claimed in claim 25, wherein the flame retardant is chosen from the group consisting of: tris(1,3-dichloroisopropyl)phosphates and dimethyl methalphosphenate.

27. The process as claimed in claim 26, wherein the flame retardant comprises from 0.25% to 5.00% by weight of the resin material.
